(19) United States
(12) Patent Application Publication
(10) Pub. No.: US 2020/0034936 A1
(43) Pub. Date: Jan. 30, 2020

(54) INSURANCE MANAGEMENT APPARATUS AND INSURANCE MANAGEMENT SYSTEM

(71) Applicants: Allm Inc., Tokyo (JP); FINANCIAL AGENCY, Inc., Tokyo (JP)

(72) Inventors: Teppei SAKANO, Tokyo (JP); Masahide SAITO, Tokyo (JP); Tadashi MASUOKA, Kanagawa (JP)

(21) Appl. No.: 16/604,204

(22) PCT Filed: Apr. 4, 2018
(86) PCT No.: PCT/JP2018/014378

§ 371 Date: Oct. 10, 2019

(30) Foreign Application Priority Data
Apr. 11, 2017 (JP) 2017-078443

(51) Int. Cl. G06Q 40/08; G06Q 30/02; G06Q 10/10; G06Q 10/06

(52) U.S. Cl. CPC G06Q 40/08; G06Q 10/063; G06Q 10/10; G06Q 30/0201

(57) ABSTRACT

An insurance management apparatus 200 includes: a storage medium for storing insurance product information including information on benefit amount depending on severity of dementia; a determination information input receiving unit for receiving an input of determination information for determining the severity of dementia of an insured person; a severity determination unit for determining the severity of dementia of the insured person based on the determination information input by the determination information input receiving unit; a benefit amount determination unit for determining the benefit amount depending on the severity of dementia determined by the severity determination unit with reference to the insurance product information; and a benefit amount recording unit for recording the benefit amount determined by the benefit amount determination unit in the storage medium.

### TECHNICAL FIELD

The present invention relates to an insurance management apparatus and an insurance management system.

### BACKGROUND ART

The following insurance service management system is known. In the insurance service management system, a long-term care certification lump sum is paid only when degree of needed care is a predetermined level (see Patent Literature 1).

### CITATION LIST

### Patent Literature

Patent Literature 1: JP-A-2013-097397

### SUMMARY OF THE INVENTION

### Problems to be Solved by the Invention

Like a long-term care insurance, there are insurance products which provide an amount of insurance when insurance subscribers meet predetermined benefit conditions. In recent years, the number of patients with dementia has increased, and there has also been insurance which provides lump sum payment to the subscribers when they are diagnosed with dementia. In insurance for dementia, since cost burden changes depending on severity of dementia, a mechanism is required to provide the amount of insurance depending on the severity of dementia of the patient. However, conventionally, no mechanism has been studied for determining the severity of dementia and providing the amount of insurance depending on the determined severity.

### Solution to the Problems

According to a first aspect of the present invention, an insurance management apparatus includes: a storage medium for storing insurance product information including information on benefit amount depending on severity of dementia a determination information input receiving unit for receiving an input of determination information for determining the severity of dementia of an insured person, including at least one of result information of neuropsychological test performed on the insured person diagnosed with dementia and head image data obtained by tomographic imaging a head of the insured person diagnosed with dementia; a severity determination unit for determining the severity of dementia of the insured person based on the determination information input by the determination information input receiving unit; a benefit amount determination unit for determining the benefit amount depending on the severity of dementia determined by the severity determination unit with reference to the insurance product information; and a benefit amount recording unit for recording the benefit amount determined by the benefit amount determination unit in the storage medium. When a determination result based on the result information of the neuropsychological test is different from a determination result based on the head image data, the severity determination unit determines the determination result based on the result information of the neuropsychological test as the severity of dementia of the insured person.

According to a second aspect of the present invention, in the insurance management apparatus of the first aspect, the result information of the neuropsychological test is information indicating results of answering questions made to the insured person, and the severity determination unit determines the severity based on the number of correct answers or the number of incorrect answers of the insured person.

According to a third aspect of the present invention, in the insurance management apparatus of the first aspect or the second aspect, the severity determination unit determines the severity of dementia of the insured person by comparing the head image data with image data at normal time obtained by imaging the head in a state where dementia does not occur.

According to a fourth aspect of the present invention, in the insurance management apparatus of the third aspect, the severity determination unit determines the severity of dementia of the insured person according to a state of change from a normal state of a characteristic site where features of dementia patients appear in a brain of the insured person, based on the head image data and the image data at the normal time obtained by imaging the head in the state where dementia does not occur.

According to a fifth aspect of the present invention, in the insurance management apparatus of the fourth aspect, the severity determination unit determines the severity of dementia of the insured person by comparing a volume of the characteristic site of the insured person with the volume of the characteristic site in the normal state to determine an atrophic state of the characteristic site.

According to a sixth aspect of the present invention, in the insurance management apparatus of the fourth aspect or the fifth aspect, the severity determination unit determines the severity of dementia of the insured person by comparing a volume of an area in which brain cells of the insured person are necrotic with the volume of the area in which the brain cells in the normal state are necrotic to determine a necrotic state of the brain cells of the insured person.

According to a seventh aspect of the present invention, the insurance management apparatus of any one of the first aspect to the sixth aspect further includes a transfer process execution unit for performing a transfer process for transferring a benefit amount determined by the benefit amount determination unit to a transfer account registered in advance.

According to an eighth aspect of the present invention, the insurance management apparatus of any one of the first aspect to the sixth aspect further includes a notification unit for notifying an insurer of the benefit amount determined by the benefit amount determination unit.

According to a ninth aspect of the present invention, an insurance management system includes: a storage medium for storing insurance product information including information on benefit amount depending on severity of dementia; a determination information input receiving unit for receiving an input of determination information for determining the severity of dementia of an insured person, including at least one of result information of neuropsychological test performed on the insured person diagnosed with dementia and head image data obtained by tomographic imaging a head of the insured person diagnosed with dementia; a severity determination unit for determining the severity of dementia of the insured person based on the determination information input by the determination information input receiving unit; a benefit amount determination unit for determining the benefit amount depending on the severity of dementia determined by the severity determination unit with reference to the insurance product information; and a benefit amount recording unit for recording the benefit amount determined by the benefit amount determination unit in the storage medium. When a determination result based on the result information of the neuropsychological test is different from a determination result based on the head image data, the severity determination unit determines the determination result based on the result information of the neuropsychological test as the severity of dementia of the insured person.

According to a tenth aspect of the present invention, in the insurance management system of the ninth aspect, the result information of the neuropsychological test is information indicating results of answering questions made to the insured person, and the severity determination unit determines the severity based on the number of correct answers or the number of incorrect answers of the insured person.

According to an eleventh aspect of the present invention, in the insurance management system of the ninth aspect or the tenth aspect, the severity determination unit determines the severity of dementia of the insured person by comparing the head image data with image data at normal time obtained by imaging the head in a state where dementia does not occur.

According to a twelfth aspect of the present invention, in the insurance management system of the eleventh aspect, the severity determination unit determines the severity of dementia of the insured person according to a state of change from a normal state of a characteristic site where features of dementia patients appear in a brain of the insured person, based on the head image data and the image data at the normal time obtained by imaging the head in the state where dementia does not occur.

According to a thirteenth aspect of the present invention, in the insurance management system of the twelfth aspect, the severity determination unit determines the severity of dementia of the insured person by comparing a volume of the characteristic site of the insured person with the volume of the characteristic site in the normal state to determine an atrophic state of the characteristic site.

According to a fourteenth aspect of the present invention, in the insurance management system of the twelfth aspect or the thirteenth aspect, the severity determination unit determines the severity of dementia of the insured person by comparing a volume of an area in which brain cells of the insured person are necrotic with the volume of the area in which the brain cells in the normal state are necrotic to determine a necrotic state of the brain cells of the insured person.

According to a fifteenth aspect of the present invention, the insurance management system of any one of the ninth aspect to the fourteenth aspect further includes a transfer process execution unit for performing a transfer process for transferring a benefit amount determined by the benefit amount determination unit to a transfer account registered in advance.

According to a sixteenth aspect of the present invention, the insurance management system of any one of the ninth aspect to the fifteenth aspect further includes a notification unit for notifying an insurer of the benefit amount determined by the benefit amount determination unit.

### Effects of the Invention

According to the present invention, it is possible to determine the benefit amount depending on the severity of dementia of the insured person, thereby providing a determined amount of insurance benefits.

### BRIEF DESCRIPTION OF THE DRAWINGS

FIG. 1 is a block diagram showing a configuration of an embodiment of an insurance management system 10.

FIG. 2 is a block diagram showing a configuration of an embodiment of an insured person terminal 100.

FIG. 3 is a block diagram showing a configuration of an embodiment of an insurance management apparatus 200.

FIG. 4 is a block diagram showing a configuration of an embodiment of an insurer terminal 300.

FIG. 5 is a flowchart showing a flow of processing performed by the insured person terminal 100.

FIG. 6 is a flowchart showing the flow of processing performed by the insurance management apparatus 200.

FIG. 7 is a flowchart showing the flow of processing performed by the insurer terminal 300.

### DESCRIPTION OF THE EMBODIMENTS

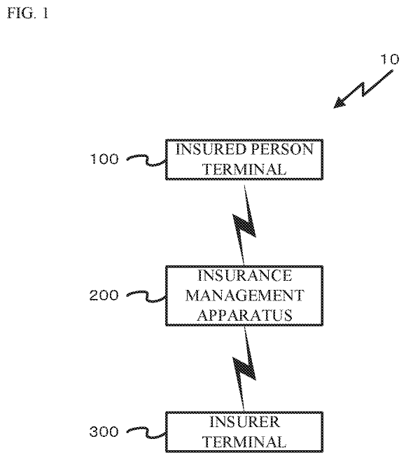

FIG. 1 is a block diagram showing a configuration of an embodiment of an insurance management system 10 in the present embodiment. In the insurance management system 10, an insured person terminal 100 operated by an insured person, an insurance management apparatus 200 which receives data from the insured person terminal 100 and performs processing, and an insurer terminal 300 installed in an insurer such as an insurance company providing insurance products related to dementia are connected via communication lines.

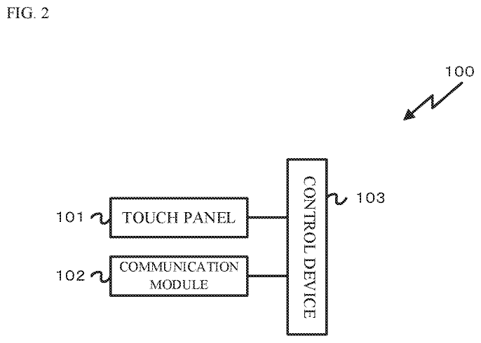

For example, a smartphone, a mobile phone, a tablet terminal, a personal computer or the like is used as the insured person terminal 100. FIG. 2 is a block diagram showing a configuration of an embodiment in which the smartphone is used as the insured person terminal 100 in the present embodiment.

The insured person terminal 100 includes a touch panel 101, a communication module 102, and a control device 103.

The touch panel 101 is an electronic component in which a display device such as a liquid crystal panel and a position input device such as a touch pad are combined, and is an input device capable of operating a device by pressing a display on a screen. For example, an operator of the insured person terminal 100 can operate the insured person terminal 100 by touching or sliding a displayed item such as a button or a menu displayed on the liquid crystal panel using a finger or a touch pen. The touch panel 101 detects an operation such as touch or slide by the operator, and outputs its detection signal to the control device 103.

The communication module 102 includes a module for connecting the insured person terminal 100 to the Internet via a LAN or a cellular phone communication network wirelessly or by wire. The insured person terminal 100 can communicate with the insurance management apparatus 200 by connecting to the Internet via the communication module 102.

The control device 103 is constituted by a CPU, a memory, and other peripheral circuits, and controls the entire insured person terminal 100. The memory constituting the control device 103 includes, for example, a volatile memory such as an SDRAM and a non-volatile memory such as a flash memory. The volatile memory is used as a work memory for the CPU to deploy a program at the time of program execution, and a buffer memory for temporarily recording the data. Further, program data of firmware for operating the insured person terminal 100 and software for operating various applications are recorded in the non-volatile memory.

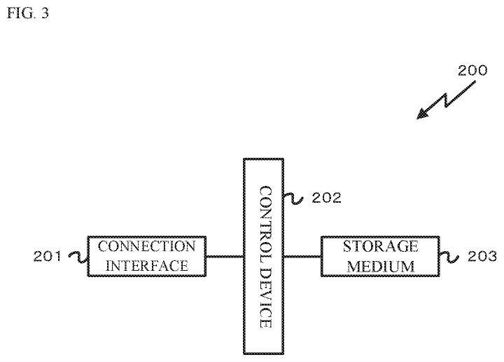

The insurance management apparatus 200 is a device connected to the Internet, and for example, the personal computer or a server is used. FIG. 3 is a block diagram showing a configuration of an embodiment in which a server device is used as the insurance management apparatus 200 in the present embodiment. The insurance management apparatus 200 includes a connection interface 201, a control device 202, and a storage medium 203.

The connection interface 201 is an interface for connecting the insurance management apparatus 200 to a communication line such as the Internet, and for example, a wired LAN module for wired connection to the Internet, a wireless LAN module for wireless connection to the Internet, or the like is used. In the present embodiment, the insurance management apparatus 200 communicates with the insured person terminal 100 and the insurer terminal 300 via the connection interface 201.

The control device 202 is constituted by the CPU, the memory, and other peripheral circuits, and controls the entire insurance management apparatus 200. The memory constituting the control device 202 is, for example, the volatile memory such as SDRAM. The memory is used as the work memory for the CPU to develop the program at the time of program execution, and the buffer memory for temporarily recording the data. For example, the data read via the connection interface 201 is temporarily recorded in the buffer memory.

The storage medium 203 is a storage medium for recording various data stored by the insurance management apparatus 200, the data of the program to be executed by the control device 202, and the like. As the storage medium 203, for example, an HDD (Hard Disk Drive), an SSD (Solid State Drive) or the like is used. The data of the program recorded in the storage medium 203 is provided by being recorded in the storage medium such as a CD-ROM or a DVD-ROM, or provided via a network, and the operator installs the obtained data of the program in the storage medium 203, so that the control device 202 can execute the program.

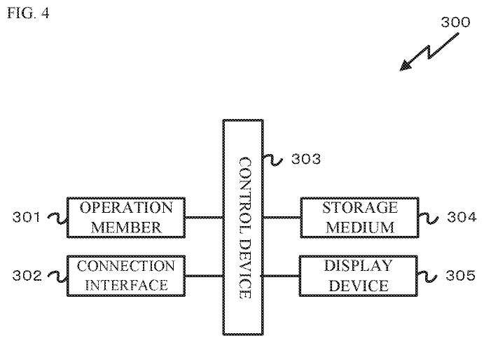

The insurer terminal 300 is a terminal installed in the insurance company which is the insurer and operated by a person in charge of the insurance company, and for example, the personal computer, the smart phone, the tablet terminal or the like is used. FIG. 4 is a block diagram showing a configuration of an embodiment when the personal computer is used as the insurer terminal 300. The insurer terminal 300 includes an operation member 301, a connection interface 302, a control device 303, a storage medium 304, and a display device 305.

The operation member 301 includes various devices, for example, a keyboard and a mouse, operated by the operator of the insurer terminal 300.

The connection interface 302 is an interface for connecting the insurer terminal 300 to another device and an external device such as a terminal. For example, the insurer terminal 300 includes an interface for connecting to the communication line such as the LAN or the Internet. The insurer terminal 300 communicates with the insurance management apparatus 200 via the connection interface 302.

The control device 303 is constituted by the CPU, the memory, and other peripheral circuits, and controls the entire insurer terminal 300. The memory constituting the control device 303 is, for example, the volatile memory such as the SDRAM. The memory is used as the work memory for the CPU to develop the program at the time of program execution, and the buffer memory for temporarily recording the data. For example, the data read via the connection interface 302 is temporarily recorded in the buffer memory.

The storage medium 304 is a storage medium for recording various data stored by the insurer terminal 300, the data of the program to be executed by the control device 303, and the like. As the storage medium 304, for example, the HDD (Hard Disk Drive), the SSD (Solid State Drive) or the like is used. The data of the program recorded in the storage medium 304 is provided by being recorded in the storage medium such as the CD-ROM or the DVD-ROM, or provided via the network, and a publisher installs the obtained data of the program in the storage medium 304, so that the control device 303 can execute the program.

The display device 305 is, for example, a liquid crystal monitor, and displays various display data output from the control device 303.

The insurance management system 10 according to the present embodiment provides a mechanism capable of determining the severity of dementia of the insured person diagnosed with dementia, and providing an amount of insurance depending on the severity.

The insurer operates the insurer terminal 300 in advance, inputs insurance product information on an insurance product for dementia, and registers it in the insurance management apparatus 200. As the insurance product information, for example, information on insurance contract conditions, a premium, and benefit amount depending on the severity of dementia of the insured person is registered. In the insurer terminal 300, the control device 303 transmits the input insurance product information to the insurance management apparatus 200. In the insurance management apparatus 200, the control device 202 records the insurance product information received from the insurer terminal 300 in the storage medium 203. The benefit amount depending on the severity of dementia of the insured person is set depending on the content of the insurance product, for example, 100 million yen when the severity of dementia of the insured person is severe, 50 million yen when the severity of dementia of the insured person is moderate, and 30 million yen when the severity of dementia of the insured person is mild.

When contracting the insurance product for dementia between the insured person and the insurer, the insured person operates the insured person terminal 100 to input contract information. The contract information includes information such as name, address, gender, date of birth and the like of the insured person. In the insured person terminal 100, the control device 103 transmits the input contract information to the insurance management apparatus 200. In the insurance management apparatus 200, the control device 202 records the contract information received from the insured person terminal 100 in the storage medium 203.

When the control device 202 of the insurance management apparatus 200 receives an input of determination information for determining the severity of dementia of the insured person, the control device 202 records the input determination information in the storage medium 203, and performs a determination process for determining the severity of dementia of the insurer based on the determination information. In the present embodiment, the determination information is input when the insured person is diagnosed with dementia, and the determination information may be input by a medical worker who has diagnosed the insured person via a medical worker terminal (not shown), input by operating the insured person terminal 100 by the insured person who has obtained test results, or input by operating the insurer terminal 300 by the insurer who has obtained the test results.

The determination information includes at least one of result information of neuropsychological test performed on the insured person diagnosed with dementia and head image data of the insured person obtained by tomographic imaging a head of the insured person diagnosed with dementia.

The result information of the neuropsychological test is information indicating results of the neuropsychological test performed by the medical worker such as a doctor or a nurse on the insured person who is a patient. As a test content, a method can be considered to ask questions, for example, the questions asking differences such as “What is differences between sugar and vinegar?”, the questions asking similarities such as “What is similarities between a pencil and a pen?”, the questions which requires calculation such as “How many 5 yen coins are for 100 yen?” or “Please subtract 3 each from 27”, the questions asking for judgment such as how to look for an object when you do not know address in a town you have never come, the questions asking for faculty of orientation such as “What's the date today?” and “What day is today?”, the questions asking for memory such as “Where were you born?”, and the questions asking for comprehension such as “What are these pictures?” after showing pictures of common things such as dogs and homes, to the insured person, and to obtain their answers. The result information of the neuropsychological test includes the data indicating whether the answer of the insured person to each question is correct or incorrect.

When the determination information recorded in the storage medium 203 includes the result information of the neuropsychological test, the control device 202 of the insurance management apparatus 200 adds 1 to a determination value for determining the severity which is set to 0 as an initial value if the answer of the insured person to each question is a correct answer, for all the questions. Thus, it is possible to calculate the determination value for determining the severity corresponding to the number of correct answers. For the questions such as “What's the date today?”, the answers to one question may be divided into a plurality of elements and an addition value to the determination value may be set for each of the elements, such that 1 is added if the month is correct, 2 is added if the day is correct, 1 is added if the day is not correct but is within 3 days before or after the day, and 1 is added if the year is correct.

The control device 202 determines the severity of dementia of the insured person by using a preset threshold value based on the determination value for determining the severity. For example, when the determination value is 0 to 5, the severity of dementia of the insured person is determined to be severe, and when the determination value is 6 to 10, the severity of dementia of the insured person is determined to be moderate, and when the determination value is 11 to 15, the severity of dementia of the insured person is determined to be mild. Note that the threshold value shown here is an example, and is not limited thereto.

The head image data of the insured person obtained by tomographic imaging the head of the insured person diagnosed with dementia assumes, for example, a CT image or an MRI image of the head of the insured person. In the present embodiment, the CT image or the MRI image including a plurality of cross-sectional images obtained by imaging a cross-section of the head of the insured person with a predetermined slice thickness is obtained in advance and recorded in the storage medium 203. The number of cross-sectional images included in the head image data of the insured person is determined by the number of imaging slices at the time of imaging. The number of imaging slices changes depending on performance and settings of the imaging device.

When the head image data of the insured person is included in the determination information recorded in the storage medium 203, the control device 202 of the insurance management apparatus 200 determines the severity according to a state of change from a normal state of a site where features of dementia patients appear in a brain of the insured person. In the present embodiment, the CT image and the MRI image obtained by imaging the head in a state where dementia does not occur are recorded in the storage medium 203 as image data at normal time in advance. The image data at the normal time is preferably the CT image or the MRI image taken before the insured person develops dementia. However, when there is no CT image or MRI image taken before the insured person develops dementia, the CT image or the MRI image of a state in which a person with an attribute similar to the insured person, for example, a person of the same age and same height as the insured person does not develop dementia may be used.

The control device 202 compares the head image data of the insured person with the image data at the normal time, to analyze the state of change of the site where features of dementia patients appear in the brain. For example, in Alzheimer's dementia, since atrophy of hippocampus in the brain, parahippocampal gyrus, and temporal parietal lobe cortex occurs prominently, the state of change of the hippocampus in the brain, the parahippocampal gyrus, and the temporal parietal lobe cortex are analyzed as characteristic sites where features of dementia patients appear in the present embodiment. In the present embodiment, an example in which the characteristic sites are three sites of the hippocampus in the brain, the parahippocampal gyrus, and the temporal parietal lobe cortex will be described, however, one or two of these sites may be the characteristic sites. Further, if it is a site where features of dementia patients appear, it will not be limited to the three sites.

The control device 202 identifies the above-mentioned characteristic sites in each of the head image data of the insured person and the image data at the normal time. Identification of the characteristic sites in the image data is performed, for example, as follows. Since shapes of the hippocampus in the brain, the parahippocampal gyrus, and the temporal parietal lobe cortex are substantially constant, matching images imitating the shapes of these sites are prepared and recorded in the storage medium 203 in advance. The control device 202 performs a matching process using the matching image for each of the head image data of the insured person and the image data at the normal time, to extract an area of characteristic sites in each of the head image data of the insured person and the image data at the normal time, so that the characteristic sites are identified.

The control device 202 calculates a volume of the characteristic site for each of the head image data of the insured person and the image data at the normal time. The volume of the characteristic site in the head image data of the insured person can be calculated by obtaining a volume per cross-sectional image by multiplying the area of the characteristic site by the slice thickness for each of the cross-sectional images constituting the head image data of the insured person, and by integrating the volume per cross-sectional image by the number of slices, that is, the number of cross-sectional images constituting the head image data of the insured person. Similarly, the volume of the characteristic site in the image data at the normal time can be calculated by obtaining the volume per cross-sectional image by multiplying the area of the characteristic site by the slice thickness for each of the cross-sectional images constituting the image data at the normal time, and by integrating the volume per cross-sectional image by the number of slices, that is, the number of cross-sectional images constituting the image data at the normal time.

The control device 202 compares the volume of target site of the insured person calculated based on the head image data of the insured person with the volume of the target site at the normal time calculated based on the image data at the normal time, and determines how much the target site of the insured person is atrophic compared with that at the normal time, to calculate the severity of dementia of the insured person. For example, when the volume of the target site of the insured person is reduced by 20% to 39% as compared with the volume of the target site at the normal time, the control device 202 determines that the severity of the dementia of the insured person is mild, when it is reduced by 40% to 59%, the control device 202 determines that the severity of the dementia of the insured person is moderate, and when it is reduced by 60% or more, the control device 202 determines that the severity of the dementia of the insured person is severe. Note that the threshold value shown here is an example, and it is not limited thereto.

Since dementia may be caused by cerebral infarction or intracerebral hemorrhage, the severity of dementia of the insured person can also be determined based on a state of necrosis of brain cells of the insured person. In the CT image, since a normal brain cell site appears white and a necrotic site appears black, it is possible to identify an area in which the brain cells are necrotic by identifying a black area in each cross-sectional image. In the MRI image, since white and black are reversed depending on settings, it is possible to identify an area in which the brain cells are necrotic as a necrotic area by identifying a white area in each cross-sectional image. The necrotic area may be identified for the entire brain, or as described below, may be identified by limiting to a site that affects the severity of dementia, for example, a frontal lobe.

The control device 202 identifies a frontal lobe portion for each of the head image data of the insured person and the image data at the normal time by the matching process described above, and calculates a volume of the area in which the brain cells are necrotic in the frontal lobe as the volume of the necrotic area. The volume of the necrotic area in the head image data of the insured person can be calculated, similarly to the volume of the characteristic site described above, by obtaining the volume per cross-sectional image by multiplying the area of the necrotic area by the slice thickness for each of the cross-sectional images constituting the head image data of the insured person, and by integrating the volume per cross-sectional image by the number of slices, that is, the number of cross-sectional images constituting the head image data of the insured person. Further, the volume of the necrotic area in the image data at the normal time can also be calculated by obtaining the volume per cross-sectional image by multiplying the area of the necrotic area by the slice thickness for each of the cross-sectional images constituting the image data at the normal time, and by integrating the volume per cross-sectional image by the number of slices, that is, the number of cross-sectional images constituting the image data at the normal time.

The control device 202 compares the volume of the necrotic area of the insured person calculated based on the head image data of the insured person with the volume of the necrotic area at the normal time calculated based on the image data at the normal time, and determines how much the brain cells of the insured person are necrotic compared with that at the normal time, to calculate the severity of dementia of the insured person. For example, when the volume of the necrotic area of the brain cells of the insured person is increased by 20% to 39% as compared with the volume of the necrotic area at the normal time, the control device 202 determines that the severity of the dementia of the insured person is mild, when it is increased by 40% to 59%, the control device 202 determines that the severity of the dementia of the insured person is moderate, and when it is increased by 60% or more, the control device 202 determines that the severity of the dementia of the insured person is severe. Note that the threshold value shown here is an example, and it is not limited thereto.

When the control device 202 obtains different determination results depending on the characteristic site and the necrotic area as a result of making determinations based on the characteristic site and the necrotic area in the above-described process, the determination result based on the head image data of the insured person is specified by a preset method. For example, the determination result determined to be the heaviest may be specified as the determination result based on the head image data of the insurer person, or the most determination results may be specified as the determination result based on the head image data of the insurer person.

The control device 202 records information indicating the severity of dementia of the insured person determined based on the determination information in the storage medium 203. At this time, when the determination information includes both the result information of the neuropsychological test and the head image data obtained by tomographic imaging the head of the insured person, and the determination result based on the result information of the neuropsychological test matches the determination result based on the head image data obtained by tomographic imaging the head of the insured person, the control device 202 records the matched determination result as severity information indicating the severity of dementia of the insured person in the storage medium 203. On the other hand, when the determination result based on the result information of the neuropsychological test and the determination result based on the head image data obtained by tomographic imaging the head of the insured person are different, the control device 202 records the determination result based on the result information of the neuropsychological test as the severity information indicating the severity of dementia of the insured person in the storage medium 203. As described above, when the determination results do not match each other, it is possible to obtain a highly accurate determination result by prioritizing and adopting the determination result based on the result information of the neuropsychological test, taking into account that the determination result based on inquiry results actually performed on the insured person by the medical worker is more accurate than the determination result based on the head image data.

The control device 202 determines the benefit amount to be paid to the insured person based on the severity information indicating the severity of dementia of the insured person recorded in the storage medium 203. Specifically, the benefit amount depending on the severity of dementia of the insured person is determined with reference to the insurance product information recorded in the storage medium 203. Then, the control device 202 records information indicating the determined benefit amount in the storage medium 203. Further, the control device 202 performs a transfer process for transferring a determined benefit amount to a transfer destination account registered in advance. Thus, the insured person diagnosed with dementia can receive the benefits depending on the severity of dementia. Note that the transfer destination account may be input by the insured person or the insurer and recorded to be included in the contract information in advance, or may be input by the insured person or the insurer at a stage of the transfer process.

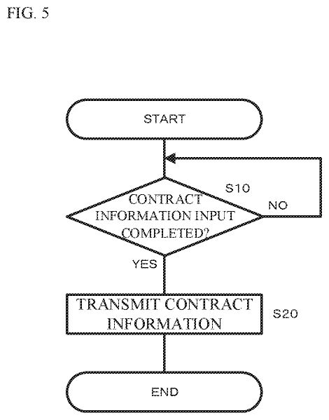

FIG. 5 is a flowchart showing a flow of processing performed by the insured person terminal 100 in the present embodiment. The processing illustrated in FIG. 5 is executed by the control device 103 as the program that is activated when the operator instructs to start input of the contract information described above.

In Step S10, the control device 103 determines whether the input of the contract information by the operator has been completed. If a positive determination is made in Step S10, the process proceeds to Step S20.

In Step S20, the control device 103 transmits the input contract information to the insurance management apparatus 200. Thereafter, the process ends.

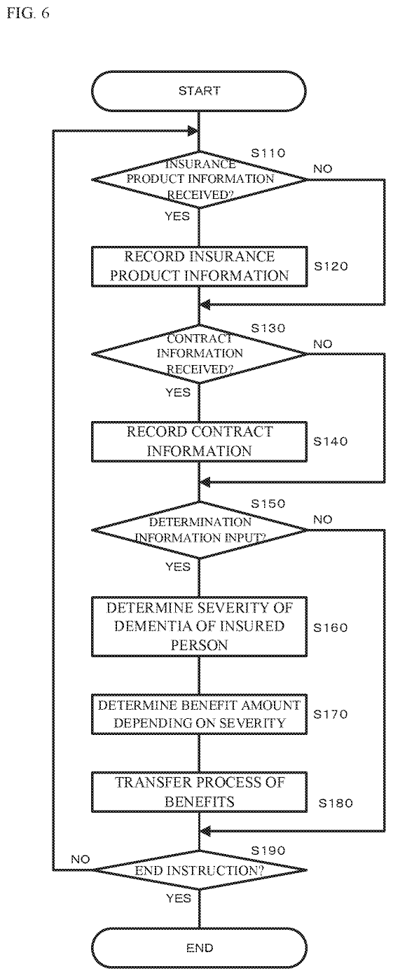

FIG. 6 is a flowchart showing the flow of processing performed by the insurance management apparatus 200 in the present embodiment. The processing illustrated in FIG. 6 is executed by the control device 202 as the program that is activated when start of the program is instructed in the insurance management apparatus 200. The start of the program in the insurance management apparatus 200 may be manually instructed by an administrator of the insurance management apparatus 200, or automatically started when the insurance management apparatus 200 is powered on.

In Step S110, the control device 202 determines whether the insurance product information described above has been received from the insurer terminal 300. If a negative determination is made in Step S110, the process proceeds to Step S130 described below. On the other hand, if the positive determination is made in Step S110, the process proceeds to Step S120.

In Step S120, the control device 202 records the received insurance product information in the storage medium 203. Thereafter, the process proceeds to Step S130.

In Step S130, the control device 202 determines whether the contract information described above has been received from the insured person terminal 100. When the negative determination is made in Step S130, the process proceeds to Step S150 described below. On the other hand, if the positive determination is made in Step S130, the process proceeds to Step S140.

In Step S140, the control device 202 records the received contract information in the storage medium 203. Thereafter, the process proceeds to Step S150.

In Step S150, the control device 202 determines whether the input of the determination information described above has been received. If the negative determination is made in Step S150, the process proceeds to Step S190 described below. On the other hand, if the positive determination is made in Step S150, the process proceeds to Step S160.

In Step S160, the control device 202 performs the above-described determination process, to determine the severity of dementia of the insured person. Thereafter, the process proceeds to Step S170.

In Step S170, as described above, the control device 202 refers to the insurance product information recorded in the storage medium 203, and determines the benefit amount depending on the degree of dementia of the insured person, to record it in the storage medium 203. Thereafter, the process proceeds to Step S180.

In Step S180, the control device 202 performs the transfer process for transferring the determined benefit amount to the transfer destination account registered in advance. Thereafter, the process proceeds to Step S190.

In Step S190, the control device 202 determines whether end of the program being executed has been instructed. When the negative determination is made in Step S190, the process returns to Step S110. On the other hand, when the positive determination is made in Step S190, the process ends.

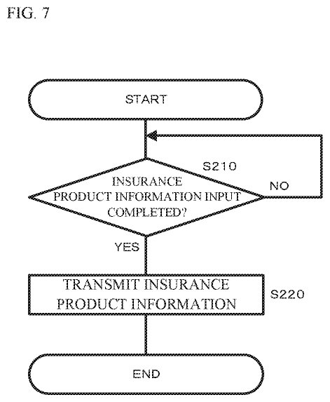

FIG. 7 is a flowchart showing the flow of processing performed by the insurer terminal 300 in the present embodiment. The processing illustrated in FIG. 7 is executed by the control device 303 as the program that is activated when the operator instructs to start input of the insurance product information described above.

In Step S210, the control device 303 determines whether the input of the insurance product information by the operator is completed. If the positive determination is made in Step S210, the process proceeds to Step S220.

In Step S220, the control device 303 transmits the input insurance product information to the insurance management apparatus 200. Thereafter, the process ends.

According to the embodiment described above, the following operational effects can be obtained.

(1) The insurance management apparatus 200 includes the storage medium 203 for recording the insurance product information including information on the benefit amount depending on the severity of dementia. The control device 202 receives the input of the determination information for determining the severity of dementia of the insured person, determines the severity of dementia of the insured person based on the input determination information, determines the benefit amount depending on the severity of dementia of the insured person with reference to the insurance product information, and records the determined benefit amount in the storage medium 203. This makes it possible to determine and record the benefit amount depending on the severity of dementia of the insured person in the insurance product for dementia.
(2) The determination information includes the result information of the neuropsychological test performed on the insured person diagnosed with dementia, and the control device 202 determines the severity of dementia of the insured person based on the result information of the neuropsychological test. This makes it possible to determine the severity of dementia of the insured person with high accuracy.
(3) The result information of the neuropsychological test is information indicating the results of answering the questions made to the insured person, and the control device 202 determines the severity based on the number of correct answers of the insured person. This makes it possible to improve determination accuracy, taking into account that the dementia patient cannot correctly answer the questions in the neuropsychological test.
(4) The determination information includes the head image data of the insured person obtained by tomographic imaging the head of the insured person diagnosed with dementia, and the control device 202 determines the severity of dementia of the insured person based on the head image data of the insured person. This makes it possible to determine the severity of dementia of the insured person with high accuracy.
(5) The control device 202 compares the head image data of the insured person with the image data at the normal time obtained by imaging the head in the state where dementia does not occur, to determine the severity of dementia of the insured person. Specifically, the control device 202 determines the severity of dementia of the insured person according to the state of change from the normal state of the characteristic site where features of dementia patients appear in the brain of the insured person, based on the head image data of the insured person and the image data at the normal time obtained by imaging the head in the state where dementia does not occur. Thus, it is possible to further improve the determination accuracy by making determination based on the state of change of the characteristic site where features of dementia patients appear.
(6) The control device 202 compares the volume of the characteristic site of the insured person with the volume of the characteristic site in the normal state, and determines an atrophic state of the characteristic site, to determine the severity of dementia of the insured person. This makes it possible to make determination taking into account that the characteristic site in the brain of the patient who has developed dementia is atrophic.
(7) The control device 202 compares the volume of the area in which the brain cells of the insured person are necrotic and the volume of the area in which the brain cells in the normal state are necrotic, and determines the necrotic state of the brain cells of the insured person, to determine the severity of dementia of the insured person. This makes it possible to make determination taking into account that dementia may be caused by cerebral infarction or intracerebral hemorrhage.
(8) The control device 202 performs the transfer process for transferring the determined benefit amount to the transfer account registered in advance. Thus, the insurer can promptly pay out the benefit amount depending on the severity of dementia of the insured person. The insured person can also receive the benefits depending on his/her degree of dementia promptly.

### —Modification—

The insurance management system of the embodiment described above can be modified as follows.

(1) In the embodiment described above, an example in which the insured person inputs the contract information has been described, however, the contract information may be input by the insurer operating the insurer terminal 300. In this case, the control device 303 of the insurer terminal 300 transmits the input contract information to the insurance management apparatus 200, and the control device 202 of the insurance management apparatus 200 may record the contract information received from the insurer terminal 300 in the storage medium 203.
(2) In the embodiment described above, an example has been described in which when the control device 202 of the insurance management apparatus 200 receives the input of the determination information for determining the severity of dementia of the insured person, the control device 202 records the input determination information in the storage medium 203, and performs the determination process for determining the severity of dementia of the insurer based on the determination information. However, when the control device 202 of the insurance management apparatus 200 receives the input of the determination information for determining the severity of dementia of the insured person, the control device 202 records the input determination information in the storage medium 203, and then when execution of the determination process is instructed from the administrator of the insurance management apparatus 200 or the insurer terminal 300, or at a predetermined timing set in advance, the control device 202 may perform the determination process on the determination information recorded in the storage medium 203.
(3) In the embodiment described above, an example has been described in which the result information of the neuropsychological test includes the data indicating whether the results of answering the questions made to the insured person are correct or incorrect, and the control device 202 of the insurance management apparatus 200 calculates the determination value for determining the severity based on the result information of the neuropsychological test. However, the result information of the neuropsychological test may include the determination value for determining the severity calculated in advance, and the control device 202 of the insurance management apparatus 200 may determine the severity of dementia of the insured person based on the determination value included in the result information of the neuropsychological test.
(4) In the embodiment described above, an example has been described in which the image data at the normal time is recorded in advance in the storage medium 203 of the insurance management apparatus 200, and the control device 202 determines the volume per cross-sectional image by multiplying the area of the characteristic site by the slice thickness for each of the cross-sectional images constituting the image data at the normal time, and calculates the volume of the characteristic site in the image data at the normal time by integrating the volume per cross-sectional image by the number of slices. However, the volume of the characteristic part in the image data at the normal time may be calculated in advance, and the calculation result may be recorded in the storage medium 203 of the insurance management apparatus 200. In this case, the control device 202 may calculate the volume of the characteristic site in the head image data of the insured person, to compare the calculated volume with the volume of the characteristic site in the image data at the normal time recorded in advance.
(5) In the embodiment described above, an example has been described in which the control device 202 determines the benefit amount to be paid to the insured person based on the severity information indicating the severity of dementia of the insured person recorded in the storage medium 203, and performs the transfer process for transferring the determined benefit amount to the registered transfer destination account. However, determination of the amount of benefit depending on the severity of dementia of the insured person, or the transfer process of the benefits may not be performed by the insurance management apparatus 200 but performed by the insurer. Or, the determination of the amount of benefit depending on the severity of dementia of the insured person may be performed by the insurance management apparatus 200, and the transfer process of the benefits may be performed by the insurer. In this case, the control device 202 may notify the insurer by notifying the insurer terminal 300 of the determined benefit amount.
(6) In the embodiment described above, an example has been described in which the severity of dementia of the insured person is determined in three stages of severe, moderate, and mild. However, the determination result is not limited to the three stages. For example, it may be determined in five stages, such as a first stage, a second stage, a third stage, a fourth stage, and a fifth stage from those with less severity, or may be other than that.
(7) In the embodiment described above, an example has been described in which the result information of the neuropsychological test is the information indicating the results of answering the questions made to the insured person, and the control device 202 calculates the determination value for determining the severity corresponding to the number of correct answers of the insured person, to determine the severity of dementia of the insured person. However, the control device 202 may calculate the determination value for determining the severity corresponding to the number of incorrect answers of the insured person, to determine the severity of dementia of the insured person.

The present invention is not limited to the configuration in the above-described embodiment as long as characteristic functions of the present invention are not impaired. Further, the above-described embodiment and a plurality of modifications may be combined.

The disclosure content of the following priority basic application is incorporated herein by reference.

Japanese Patent Application No. 2017-078443 (filed on Apr. 11, 2017)

### LIST OF REFERENCE NUMERALS

10: Insurance management system, 100: Insured person terminal, 101: Touch panel, 102: Communication module, 103: Control device, 200: Insurance management apparatus, 201: Connection interface, 202: Control device, 203: Storage medium, 300: Insurer terminal, 301: Operation member, 302: Connection interface, 303: Control device, 304: Storage medium, 305: Display device.

1. An insurance management apparatus comprising:
a storage medium for storing insurance product information including information on benefit amount depending on severity of dementia;
a determination information input receiving unit for receiving an input of determination information for determining the severity of dementia of an insured person, including at least one of result information of neuropsychological test performed on the insured person diagnosed with dementia and head image data obtained by tomographic imaging a head of the insured person diagnosed with dementia;
a severity determination unit for determining the severity of dementia of the insured person based on the determination information input by the determination information input receiving unit;
a benefit amount determination unit for determining the benefit amount depending on the severity of dementia determined by the severity determination unit with reference to the insurance product information; and
a benefit amount recording unit for recording the benefit amount determined by the benefit amount determination unit in the storage medium, wherein
when a determination result based on the result information of the neuropsychological test is different from a determination result based on the head image data, the severity determination unit determines the determination result based on the result information of the neuropsychological test as the severity of dementia of the insured person.

2. The insurance management apparatus according to claim 1, wherein
the result information of the neuropsychological test is information indicating results of answering questions made to the insured person, and
the severity determination unit determines the severity based on the number of correct answers or the number of incorrect answers of the insured person.

3. The insurance management apparatus according to claim 1, wherein the severity determination unit determines the severity of dementia of the insured person by comparing the head image data with image data at normal time obtained by imaging the head in a state where dementia does not occur.

4. The insurance management apparatus according to claim 3, wherein the severity determination unit determines the severity of dementia of the insured person according to a state of change from a normal state of a characteristic site where features of dementia patients appear in a brain of the insured person, based on the head image data and the image data at the normal time obtained by imaging the head in the state where dementia does not occur.

5. The insurance management apparatus according to claim 4, wherein the severity determination unit determines the severity of dementia of the insured person by comparing a volume of the characteristic site of the insured person with the volume of the characteristic site in the normal state to determine an atrophic state of the characteristic site.

6. The insurance management apparatus according to claim 4, wherein the severity determination unit determines the severity of dementia of the insured person by comparing a volume of an area in which brain cells of the insured person are necrotic with the volume of the area in which the brain cells in the normal state are necrotic to determine a necrotic state of the brain cells of the insured person.

7. The insurance management apparatus according to claim 1, further comprising a transfer process execution unit for performing a transfer process for transferring a benefit amount determined by the benefit amount determination unit to a transfer account registered in advance.

8. The insurance management apparatus according to claim 1, further comprising a notification unit for notifying an insurer of the benefit amount determined by the benefit amount determination unit.

9. An insurance management system comprising:
a storage medium for storing insurance product information including information on benefit amount depending on severity of dementia;
a determination information input receiving unit for receiving an input of determination information for determining the severity of dementia of an insured person, including at least one of result information of neuropsychological test performed on the insured person diagnosed with dementia and head image data obtained by tomographic imaging a head of the insured person diagnosed with dementia;
a severity determination unit for determining the severity of dementia of the insured person based on the determination information input by the determination information input receiving unit;
a benefit amount determination unit for determining the benefit amount depending on the severity of dementia determined by the severity determination unit with reference to the insurance product information; and
a benefit amount recording unit for recording the benefit amount determined by the benefit amount determination unit in the storage medium, wherein
when a determination result based on the result information of the neuropsychological test is different from a determination result based on the head image data, the severity determination unit determines the determination result based on the result information of the neuropsychological test as the severity of dementia of the insured person.

10. The insurance management system according to claim 9, wherein
the result information of the neuropsychological test is information indicating results of answering questions made to the insured person, and
the severity determination unit determines the severity based on the number of correct answers or the number of incorrect answers of the insured person.

11. The insurance management system according to claim 9, wherein the severity determination unit determines the severity of dementia of the insured person by comparing the head image data with image data at normal time obtained by imaging the head in a state where dementia does not occur.

12. The insurance management system according to claim 11, wherein the severity determination unit determines the severity of dementia of the insured person according to a state of change from a normal state of a characteristic site where features of dementia patients appear in a brain of the insured person, based on the head image data and the image data at the normal time obtained by imaging the head in the state where dementia does not occur.

13. The insurance management system according to claim 12, wherein the severity determination unit determines the severity of dementia of the insured person by comparing a volume of the characteristic site of the insured person with the volume of the characteristic site in the normal state to determine an atrophic state of the characteristic site.

14. The insurance management system according to claim 12, wherein the severity determination unit determines the severity of dementia of the insured person by comparing a volume of an area in which brain cells of the insured person are necrotic with the volume of the area in which the brain cells in the normal state are necrotic to determine a necrotic state of the brain cells of the insured person.

15. The insurance management system according to claim 9, further comprising a transfer process execution unit for performing a transfer process for transferring a benefit amount determined by the benefit amount determination unit to a transfer account registered in advance.

16. The insurance management system according to claim 9, further comprising a notification unit for notifying an insurer of the benefit amount determined by the benefit amount determination unit.
